(19) United States
(12) Patent Application Publication
(10) Pub. No.: US 2008/0294709 A1
(43) Pub. Date: Nov. 27, 2008

(54) Processing geometric data using spectral analysis

(76) Inventors: Rahul P. Sathe, Hillsboro, OR (US); Kedar Y. Hardikar, San Jose, CA (US)

Correspondence Address: TROP PRUNER & HU, PC, 1616 S. VOSS ROAD, SUITE 750, HOUSTON, TX, 77057-2631, US

(21) Appl. No.: 11/805,491

(22) Filed: May 23, 2007

(51) Int. Cl. G06F 17/14

(52) U.S. Cl. 708/405

(57) ABSTRACT

In one embodiment, the present invention includes a method for receiving vertex data corresponding to a surface of an image, performing a discrete Fourier transform (DFT) on the vertex data to obtain a frequency response, zero padding the frequency response to obtain zero padded frequency response data, and performing an inverse DFT (IDFT) on the zero padded frequency response data to obtain modified vertex data including the vertex data and additional vertex data corresponding to the surface. Other embodiments are described and claimed.

### BACKGROUND

In video processing, incoming video data is processed to prepare the data for output on a display such as an associated display of a computer system. Depending on the type and quality of the incoming data, compression or other encoding applied to the data, various filtering may be performed to improve image quality.

Many existing algorithms are very computation intensive and require significant resources to process the data. Furthermore, the output of such processing can still present graphics data of limited precision, as contour information of the incoming data may be limited.

### BRIEF DESCRIPTION OF THE DRAWINGS

FIG. 1 is a flow diagram of a method in accordance with an embodiment of the present invention.

FIG. 2 shows time domain and frequency domain functions in accordance with one embodiment of the present invention.

FIG. 3 shows time domain and frequency domain functions in accordance with another embodiment of the present invention.

FIG. 4 is a block diagram illustrating a system in accordance with one embodiment of the present invention.

### DETAILED DESCRIPTION

In various embodiments, surface information, such as vertex data of a three-dimensional (3D) surface such as a tessellated surface may be sub-divided and a spectral analysis performed to obtain a greater number of samples, thus improving an image to be generated having the surface.

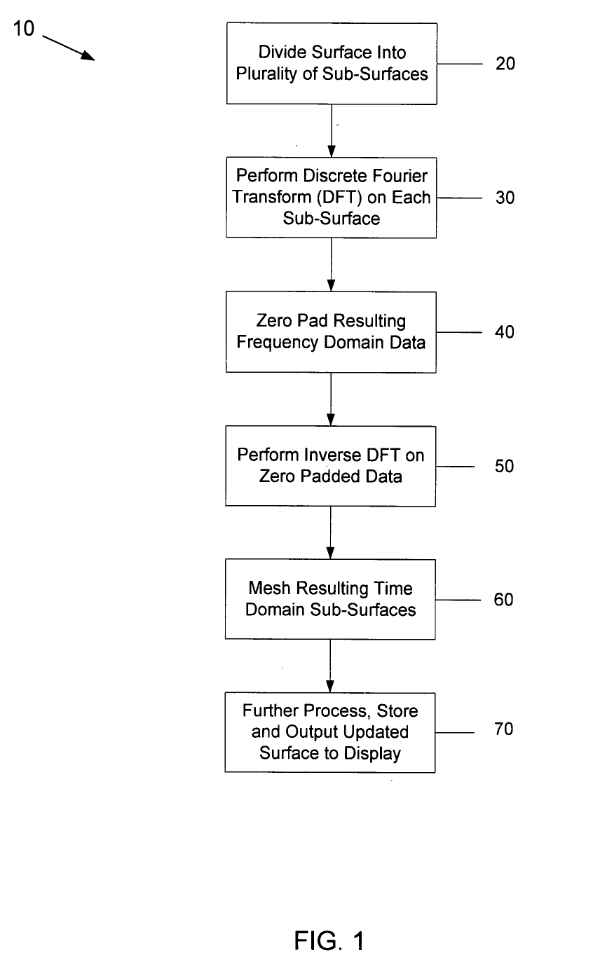

Referring now to FIG. 1, shown is a flow diagram of a method in accordance with an embodiment of the present invention. As shown in FIG. 1, method 10 may begin by dividing a surface into a plurality of sub-surfaces (block 20). For example, a processing unit such as a graphics processor, digital signal processor (DSP), or a general-purpose processor may receive incoming data, such as vertex data of a surface, e.g., a tessellated surface. This information may be sub-divided into a plurality of sub-surfaces. Then, a discrete Fourier transform (DFT) may be performed on each sub-surface (block 30). The resulting frequency domain data may then be zero padded (block 40). As will be described further below, in various embodiments the zero padding may be included in the middle of the data portion.

Still referring to FIG. 1, then an inverse DFT (IDFT) may be performed on the zero padded data to obtain time domain data (block 50). However, this updated time domain data may include many more samples due to the zero padding performed in the frequency domain. After time domain data has been obtained by the inverse DFT operations for the sub-surfaces, the resulting data of the sub-surfaces may be meshed together (block 60). For example, a mesh generation algorithm may be used to create a mesh using newly generated vertices along with the vertices from the original mesh. Finally, the resulting data, which may correspond to vertex data of a given frame of an image, can be further processed and then may be stored, e.g., in a frame buffer, and output to a display (block 70). Alternately, the data may be stored in another location for further processing. While shown with this particular implementation in the embodiment of FIG. 1, the scope of the present invention is not limited in this regard.

Embodiments can be applied to any N-dimension (D) sampled dataset that requires a smoother N-D surface. As a first example, consider a uniformly sampled signal over a time period T with N samples. Let's call that sequence f(x) defined for some values of x. Assume that the sampling frequency (=T/N) satisfies the Nyquist criterion of being greater than twice the highest frequency of the analog signal. The DFT of the signal may be performed to obtain another signal with N samples. The DFT result may be called F(u). The relationship between F(u) and f(x) can be described by the following equations EQS. 1 and 2:

$$\begin{matrix}f ( x ) = {\sum }_{x = 0}^{N - 1} F ( u ) {e}^{2 π i xu / N} & [ EQ . 1 ] \\ F ( u ) = \frac{1}{N} {\sum }_{x = 0}^{N - 1} f ( x ) {e}^{- 2 π i xu / N} & [ EQ . 2 ]\end{matrix}$$

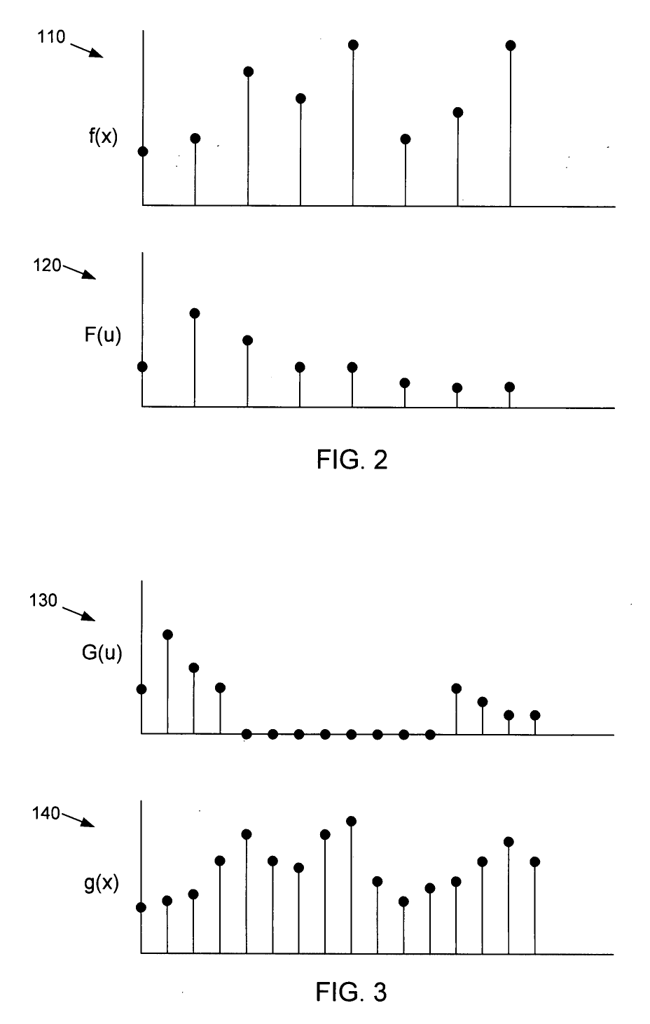

As shown in FIG. 2, function 120 is a DFT of function 110, which is a discretely sampled signal sequence f(x). Samples in the frequency domain are separated by 2*π/N, where N=8 in this case. For simplicity only the real part of F(u) is shown. F(u) will have a complex part as well that will have N (8 in this case) samples.

The resulting F(u) signal may then be zero padded, which refers to adding zeros in the sequence. Zero padding can be done in either time domain for computing DFT or in frequency domain for computing an IDFT. When additional zeros are added at the end of the sequence in the time domain, the resulting frequency response has more samples than the original frequency response. Thus, the number of samples in the frequency domain after zero padding equals the original number of samples plus the zeros added in the time domain.

Referring now to FIG. 3 function 130 (G(u)) is a DFT generated by zero padding F(u) from FIG. 2. Zeros are added by splitting the signal in the middle and adding zeros symmetrically. Samples in the frequency domain are separated by 2*π/(2*N); 2*N=16 in this case. The resulting time domain function 140 (g(x)) is the signal generated by taking the IDFT of G(u). Notice that g(x) has twice the number of samples than f(x) of FIG. 2. Note that alternate samples of g(x) match that of f(x) (with some scaling). Since by adding zeros, the number of samples is doubled, the amplitude of g(x) may be doubled as well so that alternate samples in g(x) match exactly with that of f(x).

While calculating the IDFT of a frequency response of a signal, additional zeros can be added in the middle of the frequency response. These zeros are distributed equally around a frequency of π. The frequency value of π corresponds to a higher end of the frequency domain, and hence zeros are added around frequency=π, and not at the end (at frequency=2*π). This zero padded frequency domain signal corresponds to a sequence in time domain that has more samples than the original signal. These newly generated samples in time domain are the interpolated values based on the frequency response of a signal. Alternatively, zeros can be inserted between alternate samples in the frequency response, which provide for an exact interpolation for periodic signals.

If the original sequence in the time domain is not periodic, then the frequency domain zero padding scheme exhibits a Gibbs' phenomenon in that there will be errors at the beginning and end of the interpolated time samples. When we try to approximate discontinuities in the time domain with a finite number of values in the frequency domain, ripples occur just before and after the approximated (interpolated) discontinuity in the time-domain. If the original time sequence is very large, some of the initial and final erroneous interpolated time samples may be discarded.

A tessellated surface tries to approximate some continuous surface. One heuristic is to think of the vertices of the tessellated surface as the vertices of the continuous surface that it is trying to approximate. Thus, the vertices of a tessellated surface can be thought of as a sampled signal in 2D. Accordingly, in various embodiments the 2D DFT of this 2D sampled signal may be performed, the frequency response along both the dimensions may be zero padded, and then the inverse DFT taken. This IDFT will generate a 2D signal that corresponds to the surface with more points. This newly generated surface will also contain the original sample points. These newly introduced points are generated based on the frequency distribution of the original sampled surface.

Consider a surface that is represented by M×N discrete points. Let's call these discrete points as f(x,y) with x ranging from 0, . . . , N-1 and y ranging from 0, . . . , M-1. The 2D DFT of this surface can be calculated as follows:

$$F ( u , v ) = \frac{1}{NM} {\sum }_{x = 0}^{N - 1} {\sum }_{y = 0}^{M - 1} f ( x , y ) {e}^{- 2 πi ( xu / N + yv / M )} \qquad [ EQ . 3 ]$$

Conversely, if we have a 2D frequency response of a 2D signal, the original signal can be generated as follows:

$$f ( x , y ) = {\sum }_{u = 0}^{N - 1} {\sum }_{v = 0}^{M - 1} F ( u , v ) {e}^{2 πi ( xu / N + yv / M )} \qquad [ EQ . 4 ]$$

Thus in various embodiments, a collection of sampled points (vertices of a tessellated surface) may be obtained, and a 2D DFT calculated as per Eq. 3 to generate a new sequence F(u,v). This 2D sequence may be broken exactly in the middle (at values N/2 and M/2) and a finite number of zeros inserted to generate a new 2D sequence G(u,v). Then the IDFT of this newly generated sequence G(u,v) may be taken to generate a sequence g(x,y). This sequence g(x,y) will have a higher number of samples than f(x,y). It will have the “padded number of zeros” number of additional samples. Thus, g(x,y) with appropriate scaling (in which the scaling depends on the number of zeros added) will be the newly generated surface. This surface retains original points from f(x,y) and generates new samples that are interpolated based on spectral response of the signal.

How a surface is described as a function of two variables is a matter of choice and surface properties. One can express the surface as a 2D function with two of the three Cartesian variables as independent variables, e.g., y=f(x,z), or one can use parametric description of the surface e.g., r=f(θ,Φ). For complicated surfaces that are not easily parameterizable, one can use techniques like convex decomposition or some other decomposition scheme to get simpler surfaces and then parameterize the results. Alternatively, other approaches can be used to construct a 2D image of the geometry under consideration.

In various embodiments, hardware acceleration provided for Fast Fourier Transforms (FFTs) may be leveraged to improve operation. In some embodiments, a DSP or other hardware may be used, and furthermore, some embodiments may be implemented using a user-level instruction. Accordingly, new surface data is based on spectral analysis. Embodiments may thus track the global nature of a surface to provide a rich interpolation. In some implementations, a performance-accuracy tradeoff can be made by using a smaller window on the surface and using that for calculating DFT, zero-padding and IDFT instead of the full surface. The window size (i.e., the points taken as inputs for the algorithm) depends on the memory and execution bandwidth of the hardware. Smaller patches may be smoothed out with the appropriate desired Cⁿ at the boundaries. For closed convex manifolds, we can parameterize the surface using polar co-ordinates (Φ, θ). In this case, spherical harmonics become a natural choice for interpolation based on spectral methods. Since the closed manifold generates periodic signals along Φ and θ, this kind of interpolation based on spectral analysis should yield quite good refinement. As embodiments generate new vertices, a mesh generation algorithm can be used to create a mesh using these newly generated vertices and the vertices from the original mesh.

In this way, a spectral distribution of a tessellated surface (or curve) may be used to construct a smoother surface (or curve). Accordingly, better looking surfaces may be obtained, and performance can be improved by taking advantage of hardware accelerated FFTs. In various embodiments, the highly parallel nature of methods may be amenable to multi-core solutions.

Embodiments may be implemented in an algorithm that can be executed in many different system types. For example, such systems can include digital imaging devices such as digital cameras, digital televisions, digital video devices and so forth. Similarly, embodiments may be implemented in computer systems such as server computers, personal computers, mobile devices such as cellular telephones and so forth. In such processor-based systems, an algorithm in accordance with an embodiment may be performed in a general-purpose processor such as a microprocessor, a graphics processing unit (GPU) or other such processing unit.

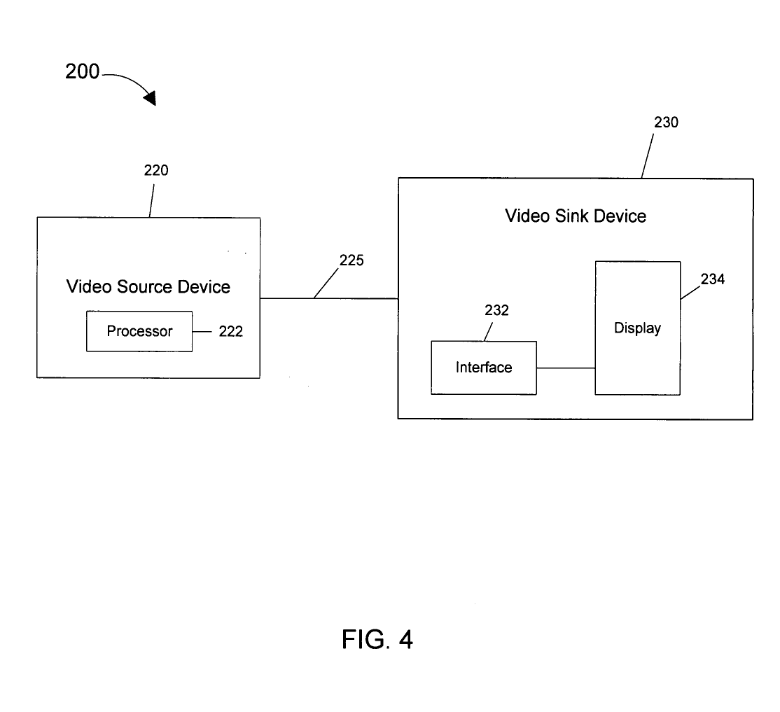

Referring now to FIG. 4, shown is a block diagram illustrating a system 200 in accordance with one embodiment of the present invention. As illustrated, a video source device 220 and a video sink device 230 are coupled to each other by digital video link 225. Video source device 220 may include a processor 222, which may be a graphics processing unit, a DSP or general-purpose processor, which may be used to perform embodiments of the present invention. Video source device 220 provides video content to video sink device 230 through digital video link 225.

Video source device 220 and video sink device 230 are both intended to represent a broad range of such devices known in the art. Examples of video source devices include but are not limited to computers of all sizes (from palm size devices to desktop devices, and beyond), set-top boxes, or digital versatile disk (DVD) players, whereas examples of video sink devices include but are not limited to cathode ray tubes (CRT) monitors, flat panel displays or television sets, such as a high definition television (HDTV). Digital video link 225 may be implemented in any one of a number of mechanical and electrical forms, as long as they are consistent with the operating requirement (i.e., speed, bit rate and so forth), and a mechanism (which may be in hardware or through protocol) is provided to allow control information to be exchanged between video source and sink devices 220 and 230 (hereinafter, simply source and sink devices respectively). Upon receipt of the video content, sink device 230 may provide stream data to an interface 232 for decryption (in some embodiments), and then unencrypted data is provided to, e.g., a display 234.

Embodiments may be implemented in code and may be stored on a storage medium having stored thereon instructions which can be used to program a system to perform the instructions. The storage medium may include, but is not limited to, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
receiving vertex data corresponding to a surface of an image;
performing a discrete Fourier transform (DFT) on the vertex data to obtain a frequency response;
zero padding the frequency response to obtain zero padded frequency response data; and
performing an inverse DFT (IDFT) on the zero padded frequency response data to obtain modified vertex data including the vertex data and additional vertex data corresponding to the surface.

2. The method of claim 1, further comprising zero padding the frequency response in a first dimension having M discrete points and a second dimension having N discrete points.

3. The method of claim 2, further comprising zero padding the frequency response in a middle portion of the frequency response, the middle portion corresponding to M/2 and N/2.

4. The method of claim 1, further comprising scaling the modified vertex data and further processing the scaled modified vertex data and outputting the processed scaled modified vertex data to a display.

5. The method of claim 4, wherein the additional vertex data is interpolated data based on a spectral response of the vertex data.

6. The method of claim 1, wherein the surface comprises a tessellated surface, the tessellated surface subdivided into a plurality of sub-surfaces and performing the DFT, the zero padding and the IDFT on each of the plurality of sub-surfaces and meshing the plurality of the sub-surfaces to obtain the tessellated surface.

7. The method of claim 1, further comprising performing the DFT, the zero padding, and the IDFT according to a user level instruction executed on a processor including a fast Fourier transformer (FFT) accelerator.

8. An apparatus comprising:
a processor to receive vertex data corresponding to a surface of an image, perform a discrete Fourier transform (DFT) on the vertex data to obtain a frequency response, zero pad the frequency response to obtain zero padded frequency response data, and perform an inverse DFT (IDFT) on the zero padded frequency response data to obtain modified vertex data including the vertex data and additional vertex data corresponding to the surface.

9. The apparatus of claim 8, wherein the processor includes a fast Fourier transformer (FFT) accelerator.

10. The apparatus of claim 8, wherein the processor comprises a digital signal processor (DSP).

11. The apparatus of claim 8, wherein the processor is to zero pad the frequency response in a first dimension having M discrete points and a second dimension having N discrete points.

12. The apparatus of claim 11, wherein the processor is to zero pad the frequency response in a middle portion of the frequency response, the middle portion corresponding to M/2 and N/2.

13. The apparatus of claim 12, further comprising a display, wherein the processor is to scale the modified vertex data, further process the scaled modified vertex data and output the processed scaled modified vertex data to the display, wherein the additional vertex data is interpolated data based on a spectral response of the vertex data.

14. A system comprising:
a video source device including a processor to receive vertex data corresponding to a surface of an image, perform a discrete Fourier transform (DFT) on the vertex data to obtain a frequency response, zero pad the frequency response to obtain zero padded frequency response data, and perform an inverse DFT (IDFT) on the zero padded frequency response data to obtain modified vertex data including the vertex data and additional vertex data corresponding to the surface.

15. The system of claim 14, wherein the processor includes a fast Fourier transformer (FFT) accelerator and the processor is to zero pad the frequency response in a first dimension having M discrete points and a second dimension having N discrete points.

16. The system of claim 14, wherein the video source device is coupled to a video sink device via a digital link.
